(19) United States
(12) Patent Application Publication
(10) Pub. No.: US 2005/0234984 A1
(43) Pub. Date: Oct. 20, 2005

(54) Periodic dynamic updating of content and metadata on a client

(76) Inventors: Dale E. Rogerson, Seattle, WA (US); Sridhar Chandrashekar, Redmond, WA (US); J. Shane McRoberts, Seattle, WA (US)

Correspondence Address: WOODCOCK WASHBURN LLP, ONE LIBERTY PLACE - 46TH FLOOR, PHILADELPHIA, PA, 19103, US

(21) Appl. No.: 10/819,598

(22) Filed: Apr. 7, 2004

(51) Int. Cl. G06F 7/00

(52) U.S. Cl. 707/104.1

(57) ABSTRACT

Periodic updating of content and metadata on a client computer is enabled through the transmission of a patch, rather than redeployment of the entire content and metadata. The patch contains difference information detailing the differences between the client's version of the content and metadata and a current version. The content and metadata are updated consistent with the patch. Any associated information with the content and metadata, such as a full text index or a data store, will then also be updated or recreated. Because the patch is smaller than information needed to redeploy the content, metadata, and associated information, it can be sent with greater frequency and security. Additionally, because the patch is based on the client's version of the content and metadata and a current version, where a number of current versions exist (e.g. for localization) the correct patch may be sent out without requiring the transmission of extraneous content or metadata.

### FIELD OF THE INVENTION

This invention relates in general to the field of information technology. More particularly, this invention relates to the creation and updating of content and metadata in a system such as a help system on a client computer.

### BACKGROUND OF THE INVENTION

Often, when providing a computer component for use by a user, the utility of the computer component (e.g., a software application) to the user will be greatly enhanced by making an on-line help system available to the user. Such an on-line help system can be made up of several different files and components that are assembled to present the user with help information.

Some help systems include both content files and metadata files. Content files contain the actual content—text, graphics, and other elements—that appears in help topics. Metadata files contain all other information regarding how the help system will operate, how content will be presented, and how users will navigate through help topics. In some cases, content files may include some metadata as well. Metadata may be used to improve the relevance of search results. For example, where multiple possible search results are presented to a user, they may be ordered by predicted utility to the user, and this ordering will be based on metadata.

In some help systems, full text search stores or metadata stores (such as tables of contents, help indexes and/or full-text index files) are also included so that the user can access the help information via a table of contents or an index of key terms presented in the help system.

Depending on the way such a help system is created, a project file may also be used to manage all the files in the help system. This allows the help system, including content files, metadata files, and full text search stores or metadata stores to be compiled into one help file which is accessed by the user when the user requests help. The help system may be distributed with the software application(s) for which it provides user assistance or, in the case of applications which are entirely meant to provide a help system (such as “how to” electronic guides, tutorials about a product, etc.) the help system is distributed on its own.

A help system must be accurate, discoverable, and current in order for a user of the help system to be satisfied with it. This may require reasonably frequent updating of the help system. Such updating allows help system authors to produce any corrective or additional content or metadata necessary to ensure that that the accuracy, discoverability, and currency of the assistance can be improved over time. For example, in some systems implicit or explicit user feedback about the assistance may be used to update the help system in order to provide improvements.

The necessity of updating a help system is further intensified by the fact that it may be difficult, in some cases, to do all of the necessary work on a help system associated with a software application so that it can be packaged along with the associated software application until the software application's features are finalized. Because software producers are under pressure to release software applications when they are finalized, the help systems which are released with the software applications may be preliminary or incomplete. Due to cost considerations, however, help systems are generally updated only when the software application is updated. For example, a service pack for a software application may be issued to update a software application. The service pack may also include a revised help system. However, such a service pack is generally only issued infrequently, for example once every eighteen months, so as not to require a user to continually perform updates to their software. Thus, using service packs to update a help system may means any deficiencies in the help system which are identified may not be remedied for an extended period of time. In order to perform an update, such as a service pack, significant cost is incurred. Thus, issuing a service pack or other update for the purpose of updating help system information is often not feasible nor is it the most practical way to provide a useful help system to users.

Additionally, help may require localization. For example, help systems may include help in a specific language, or with instructions specific to a certain region. Because the information needed to support such localization is voluminous, it may be impractical to include the localization information in service pack or other update. Thus, localized help information may not be updated with service pack or other updates.

Help system information may be relied upon by customers in their use of a software application. If help system information is updated by an illegitimate source, the value of the software application to the customer may be interfered with. Thus, updates to help information must be trustworthy. This may be difficult if attempts to update a help system other than via an official service pack are used.

Thus, there is a need for a system and method to overcome these deficits in the prior art. The present invention addresses the aforementioned needs and solves them with additional advantages as expressed herein.

### SUMMARY OF THE INVENTION

The invention allows for efficient and secure updates to a help system by providing a patch. The patch includes information regarding differences in content data for a help system and/or metadata for the help system. This allows the content and metadata to be stored at a client computer and updated with the patch. Any related help system files such as full text indices or metadata stores can be updated consistent with the information in the patch, or rebuilt consistent with the newly updated content and/or metadata.

The authoring and deployment of such a help system is also discussed. Deployment of a help system is possible by receiving content data and metadata, and updating one or both of them according to information received in a patch.

Other features of the invention are described below.

### BRIEF DESCRIPTION OF THE DRAWINGS

The foregoing summary, as well as the following detailed description of preferred embodiments, is better understood when read in conjunction with the appended drawings. For the purpose of illustrating the invention, there is shown in the drawings exemplary constructions of the invention; however, the invention is not limited to the specific methods and instrumentalities disclosed. In the drawings:

FIG. 1 is a block diagram of an exemplary computing environment in which aspects of the invention may be implemented;

FIG. 2 is a block diagram of an authoring system according to one embodiment of the invention;

FIG. 3 is a block diagram of an initial deployment of a help system to a client system according to one embodiment of the invention;

FIG. 4 shows the creation of help system files at the client computer according to one embodiment of the invention;

FIG. 5 illustrates the updating of help content according to one embodiment of the invention;

FIG. 6 illustrates the application of the patch to the help system on client 310;

FIG. 7 is a flow diagram of a method for deploying a content display system according to one embodiment of the invention; and

FIG. 8 is a flow diagram of a method for updating a content display system according to one embodiment of the invention.

### DETAILED DESCRIPTION OF ILLUSTRATIVE EMBODIMENTS

Overview

Periodic updating of content and metadata on a client computer is enabled through transmission of a patch. The transmission of the patch may occur through any means, e.g. via the Internet or a CD-ROM. The patch is smaller than a redeployment of the entire help system would be, and therefore may be sent more often and with greater security. The patch is received by a client computer with a first version of the content and metadata. The patch describes the differences between a current version of the content and metadata and the first version resident on the client computer. The content and metadata are updated consistent with the patch. Any associated information with the content and metadata, such as a full text index or a data store, will then also be updated or recreated.

Because the patch is based on the client's version of the content and metadata and a current version, where a number of current versions exist the correct patch may be sent out without requiring the transmission of extraneous content or metadata. Thus if the client contains a version which is specific to a given language or other localization factor, the patch sent to the client can include the data necessary to update that version to a current version for that given language or localization factor, without requiring the transmission of extraneous data (e.g. for other languages.)

A help system will be used in this specification to describe the invention, however, the invention is not limited to use in help systems, but rather can be more widely used, for example, in other systems where content and metadata is distributed and it is desirable thereafter to update the content and/or metadata.

Exemplary Computing Environment

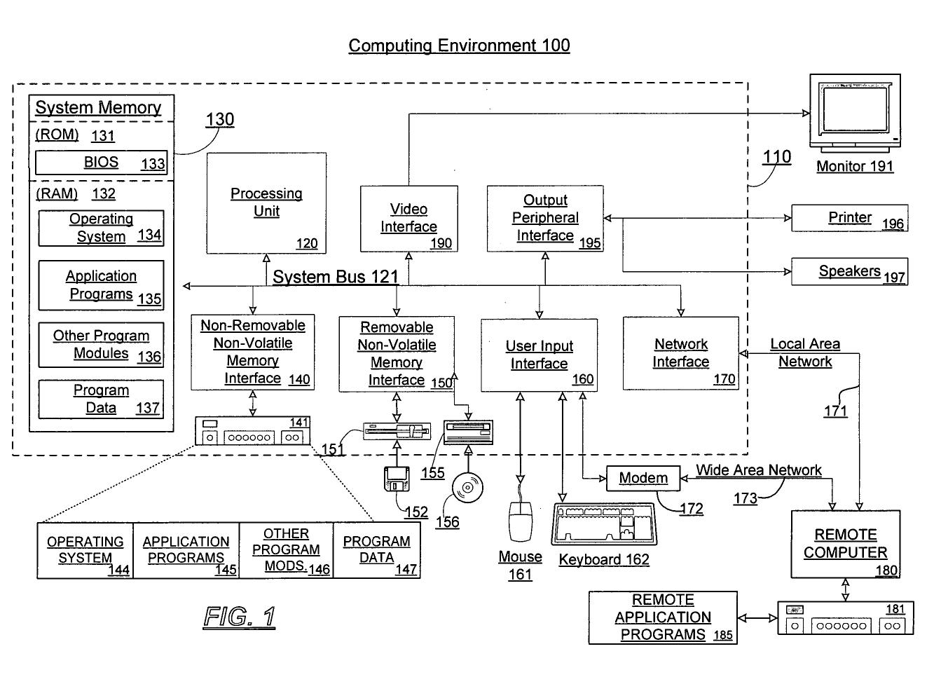

FIG. 1 shows an exemplary computing environment in which aspects of the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, embedded systems, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network or other data transmission medium. In a distributed computing environment, program modules and other data may be located in both local and remote computer storage media including memory storage devices.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The processing unit 120 may represent multiple logical processing units such as those supported on a multi-threaded processor. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus). The system bus 121 may also be implemented as a point-to-point connection, switching fabric, or the like, among the communicating devices.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156, such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

Authoring Help System Information

In order to provide help system information, first such help system information must be authored. Authoring may be accomplished by a human author and/or by other means. Information is gathered or created which describe the functioning of the software application (or other focus of the help system.)

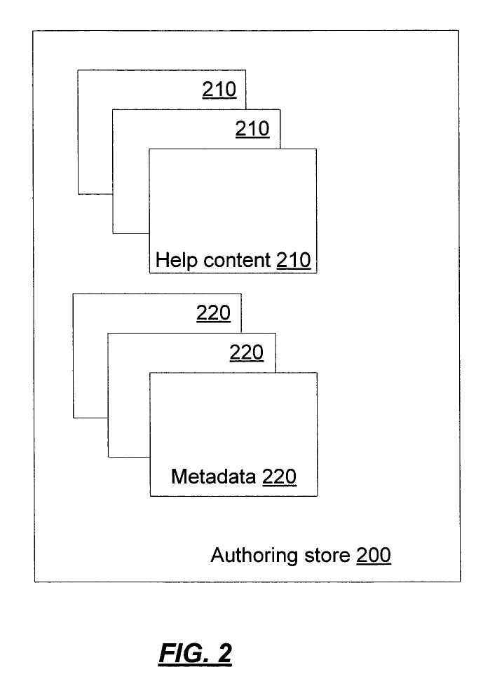

FIG. 2 is a block diagram of an authoring system according to one embodiment of the invention. In order to author help system information, as shown in FIG. 2, help content 210 and metadata information 220 are maintained and persisted in an authoring store 200. The actual structure of authoring store 200 may be to store contents in a database, on a disk or in any storage mechanism.

While help system information may be authored in any format, in one embodiment, help system information which is deployed to a client computer is stored in a specific XML (extensible markup language) schema. For example, one such XML-based markup language which can be used to author help content is the Microsoft Assistance Markup Language (MAML). Content authored in MAML can be transformed to a variety of output formats, such as Dynamic Hypertext Markup Language (DHTML) or Rich Text Format (RTF) for presentation to a user.

Versioning of the help system information is tracked. For example, a version tracking store may be used in order to track different versions of the help content 210 and the metadata information 220 to be used by the help system.

Building Help System Information

When a releasable initial version of help system information is achieved, a build is performed. The build results in help files, dynamic link library (DLL) files and other build files. The help content 210 and metadata information 220 are then compiled into packages for distribution. Component packaging includes building a system image which is ready for deployment to a user. The components are assigned a version number for tracking of distributed files.

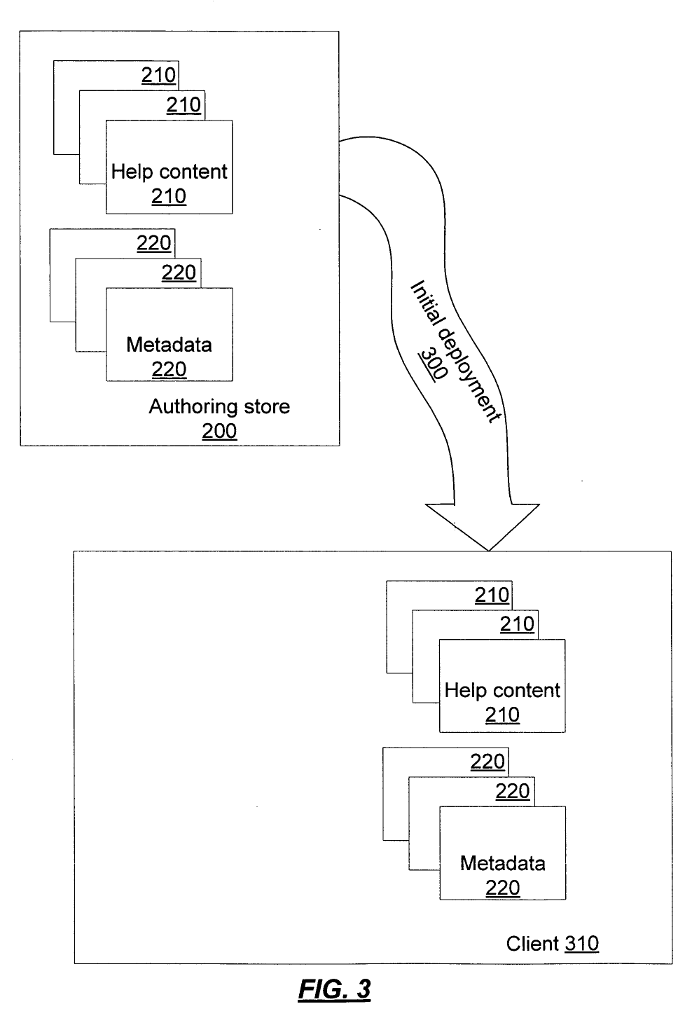

When a built component package is finished, it may be deployed to a user. If the help system is a help system to assist a user using a software application, the deployment may be performed along with the deployment of the software application. FIG. 3 is a block diagram of an initial deployment of a help system to a client system according to one embodiment of the invention. When a help component package consisting of help content files 210 and metadata files 220 is deployed to a user, as shown by initial deployment 300, the client computer receives its own copy of the metadata files 220 and the help content files 210.

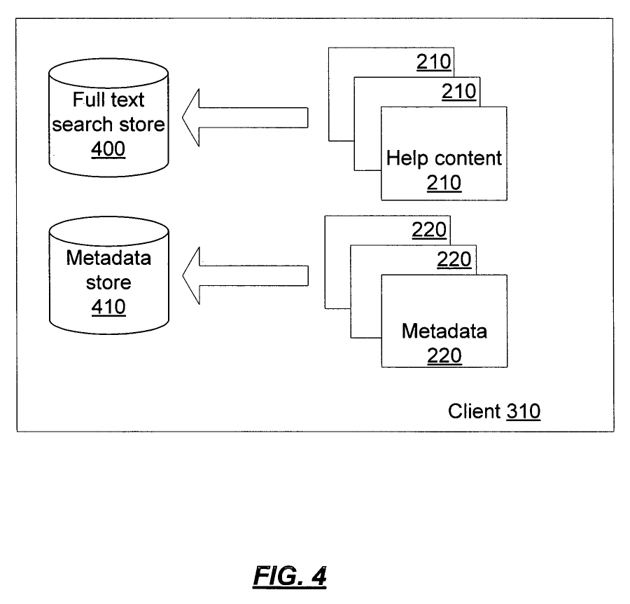

FIG. 4 shows the creation of help system files at the client computer according to one embodiment of the invention. As seen in FIG. 4, within client 310, a full text search store 400 is created from the help content 210. Additionally, a metadata store 410 is created from metadata 220.

The full text search store 400 allows a user to search perform an efficient full text search of the help content 210 using Boolean, wildcard, and nested expressions. In some embodiments, a user can also limit the search to previous results, match similar words, or search topic titles only. The full text search store 400 is created, for example, when the help system is deployed or when a full text search is first requested. Once it has been created, it can then be used to allow fast full text searching of the help content 210.

The metadata store 410, in one embodiment, includes a help index. Generally, help systems include help indexes to help users locate help information. Adding an index to a help system is one of the most important ways to get users quickly to the information they need. Some usability studies have shown that users will more frequently use a well-planned index to locate topics than they will a table of contents or full-text search.

A help index lists a number of help keywords for the user to select from. A user clicks a keyword listed in the index. The index then either takes them directly to the topic containing the information they are looking for, or to a list of topics that contain the keyword.

The index contains keywords specified by the author of the help system. For example, an index can contain terms for beginners and advanced users, synonyms for terms, terms that describe topics generally, and terms that describe topics specifically. In this way, an index can provide users with many different ways to get to topics in order to make it more likely it is that users will find the topic they need. Similarly, a table of contents provides a different, hierarchical view of the content. Users can navigate or brows the table of contents to find help topics to view.

In one embodiment, an index is designed so that it contains first and second level entries. First-level entries describe a general category. Second-level entries are indented under the first-level entries and describe specific topics within that category. In some help systems, an unlimited number of help levels are provided.

As with the full text search store 400, the metadata store 410 can be created when the help system is first installed or deployed, or it can be created when certain functionality is requested. For example, when the metadata store 410 includes a help index, the metadata store 410 may be first created when the help index is first requested by a user.

Updating Help System Information

Because the full text search store 400 and the metadata store 410 are first created on the client 310, the content which is received by the client 310 during the initial deployment of the help system consists only of the somewhat simpler help content files 210 and metadata 220. Thus, when help system updates are created, only the updated information needs to be received at the client.

There are many commonly used techniques for tracking versions of data and for describing the difference between versions. For example, a simple binary diff (short for “difference”) may be used to create a file which describes the difference between two versions. Therefore, when the help content 210 and the metadata 220 are modified, only the difference between the original versions and the new ones needs to be communicated to a client where the original versions had been installed.

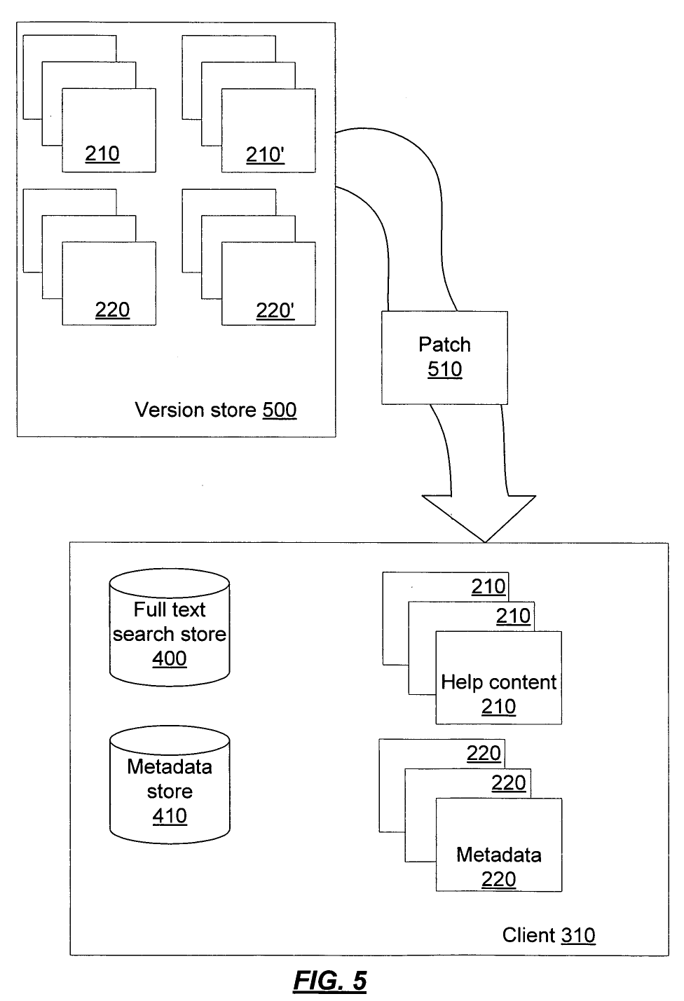

FIG. 5 illustrates the updating of help content according to one embodiment of the invention. As shown in FIG. 5, a version store 500 now contains both the original version of the help content 210 and the revised version of the help content 210′. Additionally, the version store 500 contains both an original version of metadata 220 and a revised version of metadata 220′. The differences between the original versions of the files and the revised versions is determined, and sent to the client 310 in the form of a patch 510. Because the patch 510 includes only information relevant to the changes, it is generally far smaller than help content 210′ and metadata 220′. Thus, sending the patch 510 (from the help content authors' perspective) and obtaining the patch 510 (from the client 310's perspective) is more convenient and lower cost process.

Version store 500 may include many versions of the help content 210 and metadata 220, including one or more current versions of each, and the patch 510 may be sent in response to a request from the client 310 including version information about the version resident on client 310. In this way, the correct patch 510 describing differences between that resident version and the current version is sent to the client 310. There may be more than one current version of help content 210 and metadata 220, for example where a number of versions are available to support different languages. Therefore, in the request, other information may also be included in order to provide the correct patch 510 to the client 310.

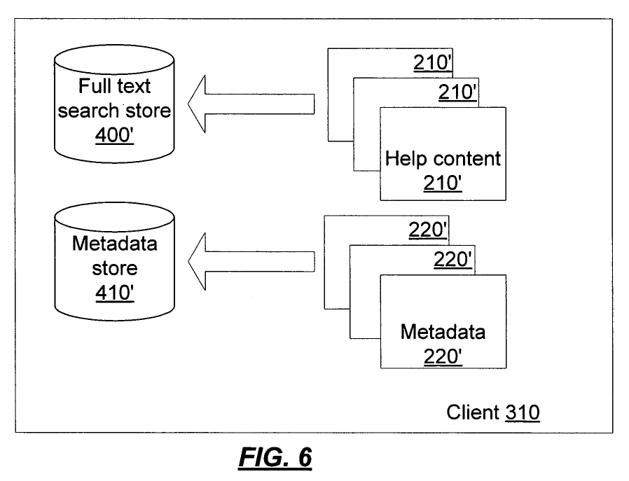

FIG. 6 illustrates the application of the patch to the help system on client 310. After any verification of the patch 510 is completed, the help content files are updated using the information in patch 510 to form revised help content files 210′, as are the metadata files to form revised metadata files 220′. These files are then used to update or recreate the stores, resulting in full text search store 400′ and metadata store 410′. These are used, as described above, in the operation of the help system. Additionally, as described above, these stores may be created either upon the update of the help content and metadata files 210′ and 220′ or when necessitated by user requests.

In one embodiment, all or part of the full text search store 400 and the metadata store 410 are created using storage with dynamic database capabilities such as WinFS (Windows Future Storage, a file system from Microsoft Corporation), and SQL databases (databases which use SQL language for creating, updating and, querying. Such storage allows updates (resulting in updated full text search store 400′ and metadata store 410′) to be performed without requiring a full recreation of the store. For example, where index terms are added via a patch 510, only the index terms added need to be changed to result in the metadata store 410′. An entire rebuilding of the index is not necessary. Similarly, if index terms are modified or removed, only changes rather than a complete rebuilding of the index is not necessary.

Deploying the Help System

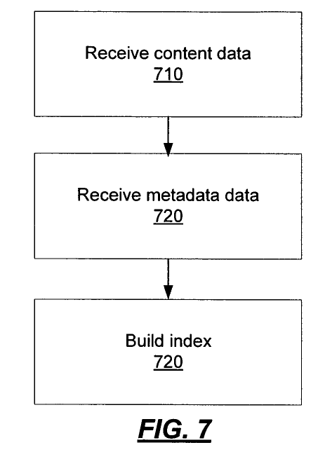

With reference again to FIG. 3, the help system is deployed when help content 210 and metadata 220 information is sent to the client 310. With reference again to FIG. 4, a full text search store 400 is created from the help content 210 and a metadata store 410 is created from metadata 220. The deployment is further illustrated in FIG. 7. FIG. 7 is a flow diagram of a method for deploying a content display system according to one embodiment of the invention. In FIG. 7, the content data is received in step 710 and the metadata is received in step 720. While these steps 710 and 720 are shown as occurring in sequence with step 710 occurring first, these steps may be performed in any order or at the same time. When both the content data and the metadata have been received, an index is built in step 730.

Updating the Help System

With reference again to FIG. 5, the help system is updated when a version store includes a new version of the help content 210′ or metadata 220′. Updates of either or both of these, in the form of a patch 510 is sent to the client 310. The patch 510 includes difference information. This difference information includes one or both of a content data difference information and metadata difference information. Content data difference information includes the differences between a current version of help content 210′ and a previous version of help content (such as help content 210). Metadata difference information includes the differences between a current version of metadata 220′ and a previous version of metadata (such as metadata 220). The patch 510 is used to update content data on the client 310 (if the patch 510 contains content data difference information). The patch 510 is also used to update metadata difference information on the client 310 (if the patch 510 contains metadata difference information).

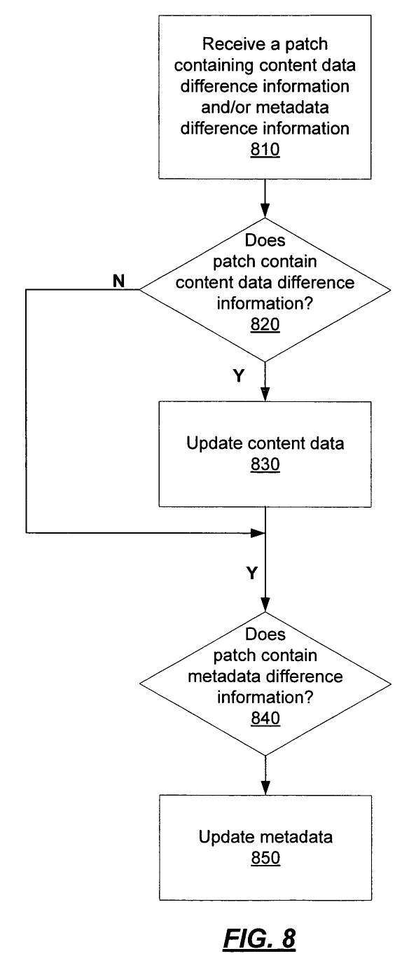

FIG. 8 is a flow diagram of a method for updating a content display system according to one embodiment of the invention. In FIG. 8, the first step in updating such a system is receiving a patch containing content data difference information and/or metadata difference information, step 810. When this information is received, if the patch contained content data difference information (decision 820), the content data is updated (step 830). If the patch contained metadata difference information (decision 840), the metadata is updated (step 850). While decision 820 and step 830 in FIG. 8 are shown as occurring before decision 840 and step 850, the decision 820 and step 830 may be accomplished after decision 840 and step 850, or at the same time as decision 840 and step 850.

### CONCLUSION

It is noted that the foregoing examples have been provided merely for the purpose of explanation and are in no way to be construed as limiting of the present invention. While the invention has been described with reference to various embodiments, it is understood that the words which have been used herein are words of description and illustration, rather than words of limitations. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects.

1. A method for updating content on a content display system, said content display system comprising content data for display to a user and metadata, said metadata comprising data regulating the display of such content data, said method comprising:
receiving a patch comprising at least one of: content data difference information describing one or more differences between said content data and an updated version of said content data; and metadata difference information describing one or more differences between said metadata and an updated version of said metadata;
if said patch comprises said content data difference information, updating said content data consistent with said content data difference information; and
if said patch comprises said metadata difference information, updating said metadata consistent with said metadata difference information.

2. The method of claim 1, where said content display system is a help system.

3. The method of claim 2, where said help system comprises a full text index and where said method further comprises:
updating said full text index using information from said patch.

4. The method of claim 2, where said help system comprises a metadata store and where said method further comprises:
updating said metadata store using information from said patch.

5. The method of claim 1, where said method is performed on a client computer system, and where said patch is received from a source external to said client computer system.

6. The method of claim 5, further comprising:
sending version information describing the current version of said content data and said metadata on said client computer system to said source external to said client computer system.

7. At least one of an operating system, a computer readable medium having stored thereon a plurality of computer-executable instructions, a co-processing device, a computing device, and a modulated data signal carrying computer executable instructions for performing the method of claim 1.

8. A method for deploying content on a content display system on a client computer system, said content display system comprising content data for display to a user and metadata, said metadata comprising data regulating the display of such content data, said method comprising:
receiving said content data from a source external to said client computer system;
receiving said metadata from a source external to said client computer system;
building a full-text index from said content data.

9. The method of claim 8, where said method further comprises:
building a metadata store from said metadata files.

10. The method of claim 8, where said content display system is a help system.

11. The method of claim 8, further comprising:
receiving a patch comprising at least one of: content data difference information describing one or more differences between said content data and an updated version of said content data; and metadata difference information describing one or more differences between said metadata and an updated version of said metadata;
if said patch comprises said content data difference information, updating said content data consistent with said content data difference information; and
if said patch comprises said metadata difference information, updating said metadata consistent with said metadata difference information.

12. At least one of an operating system, a computer readable medium having stored thereon a plurality of computer-executable instructions, a co-processing device, a computing device, and a modulated data signal carrying computer executable instructions for performing the method of claim 8.

13. A system for updating content on a content display system, said content display system comprising content data for display to a user and metadata, said metadata comprising data regulating the display of such content data, said system comprising:
patch receiving means for receiving a patch comprising at least one of: content data difference information describing one or more differences between said content data and an updated version of said content data; and metadata difference information describing one or more differences between said metadata and an updated version of said metadata; and
updating means for, if said patch comprises said content data difference information, updating said content data consistent with said content data difference information and for if said patch comprises said metadata difference information, updating said metadata consistent with said metadata difference information.

14. The system of claim 13, where said content display system is a help system.

15. The system of claim 14, where said help system comprises a full text index and where said system further comprises:
a full text index updating means for updating said full text index using information from said patch.

16. The system of claim 13, where said help system comprises a metadata store and where said system further comprises:
metadata store updating means for updating said metadata store using information from said patch.

17. The system of claim 13, where said system is performed on a client computer system, and where said patch is received from a source external to said client computer system.

18. The system of claim 17, further comprising:
a version transmitter for sending version information describing the current version of said content data and said metadata on said client computer system to said source external to said client computer system.

19. A system for deploying content on a content display system on a client computer system, said content display system comprising content data for display to a user and metadata, said metadata comprising data regulating the display of such content data, said system comprising:
content data receiver for receiving said content data from a source external to said client computer system;
metadata receiver for receiving said metadata from a source external to said client computer system;
full-text index builder for building a full-text index from said content data.

20. The system of claim 19, where said system further comprises:
metadata store builder for building a metadata store from said metadata files.

21. The system of claim 19, where said content display system is a help system.

22. The system of claim 19, further comprising:
patch receiving means for receiving a patch comprising at least one of: content data difference information describing one or more differences between said content data and an updated version of said content data; and metadata difference information describing one or more differences between said metadata and an updated version of said metadata; and
updating means for, if said patch comprises said content data difference information, updating said content data consistent with said content data difference information and for if said patch comprises said metadata difference information, updating said metadata consistent with said metadata difference information.
